(19) United States
(12) Patent Application Publication
(10) Pub. No.: US 2007/0120355 A1
(43) Pub. Date: May 31, 2007

(54) Instruction manual of electronic device

(75) Inventor: Nobuo Tsukamoto, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/602,964

(22) Filed: Nov. 22, 2006

(30) Foreign Application Priority Data
Nov. 28, 2005 (JP) 2005-342493

(51) Int. Cl. B42D 1/00

(52) U.S. Cl. 281/15.1

(57) ABSTRACT

The invention provides an instruction manual capable of storing documents such as guarantee certificates easily thereto. An instruction manual 1 of an electronic device having its rear portion 2 bound in a spreadable manner has a back cover 3 disposed on the outer side of the instruction manual and a paper portion 4 overlapped therewith which are bound together at their upper edges 5, lower edges 6 and side edges 9, thereby forming a document storage portion 7 between the back cover 3 and the paper portion 4. The back cover 3 has a document insertion slot 12. Thus, documents such as a guarantee certificate 11 can easily be stored in the document storage portion 7 through document insertion slots 12 without having to open the instruction manual 1.

The present application is based on and claims priority of Japanese patent application No. 2005-342493 filed on Nov. 28, 2005, the entire contents of which are hereby incorporated by reference.

### BACKGROUND OF THE INVENTION

1. Field of the invention

The present invention relates to an instruction manual that comes with electronic devices, and more specifically, relates to an instruction manual for electronic devices capable of storing documents such as guarantee certificates within the instruction manual.

2. Description of the Related Art

In recent years, products such as electronic devices have packed together in a package the product body, attachments thereof such as the remote controller and batteries, an “instruction manual”, a “guarantee certificate” and other documents such as a “notification paper” notifying the user of special precautions and reminders related to the handling of the product. Usually, such documents are packed in a single pouch and stored in the package, or in some cases, the “guarantee certificate” is bonded to the upper cover of the package or the like so as to enable the staff at the dealer to take out the certificate easily.

Japanese Utility Model Application Laid-Open Publication No. 6-16072 (patent document 1) discloses a note with a pocket for storing memos and cards therein, wherein a U-shaped pocket-forming sheet is bonded to the inner side of a front cover of a note. Furthermore, Japanese Patent Application Laid-Open Publication No. 2001-219670 (patent document 2) discloses a book having a folded-back portion with an insertion opening for inserting CDs, printed documents or the like, wherein the peripheral edge of the folded-back portion which is folded back to the inner side from the front cover of the book is bonded to the inner side of the front cover.

However, according to the disclosure of patent document 1, in order to insert memos and other objects in the pockets, the notebook must be opened at first. Further, also according to the disclosure of patent document 2 in which thin objects are stored in the pockets through insertion openings formed on the inner side of the cover of the book, the book must be opened at first in order to store the objects in the pockets. In other words, according to the disclosure of patent documents 1 and 2, memos and other objects cannot be stored without opening the notebook or booklet, so the usability of the notebook or booklet was not good.

### SUMMARY OF THE INVENTION

In consideration of the above problems of the prior art, the present invention aims at providing an instruction manual of an electronic device capable of storing documents such as the guarantee certificate that comes with the electronic device easily without having to open the instruction manual.

According to a first aspect of the present invention, an instruction manual of an electronic device has a rear portion bound so as to enable the instruction manual to spread in the horizontal direction; wherein upper edges, lower edges and side edges opposite from said rear portion of a back cover of the instruction manual and a paper portion overlapped with the back cover are bound together to form a document storage portion between the inner side of the back cover and the paper portion, with a document insertion slot formed on the back cover.

According to the arrangement of the first aspect, documents such as the guarantee certificate that come with the electronic device are inserted through the document insertion slots formed to the instruction manual so that they can be kept without being lost, and the documents are stored easily through the document insertion slots into the document storage portion without having to open the instruction manual, since the document insertion slots are formed on the outer side of the back cover of the instruction manual.

A second aspect of the present invention provides an instruction manual of an electronic device having a rear portion bound so as to enable the manual to spread in the horizontal direction; comprising a paper slip folded in half so that a paper portion thereof overlaps with a back cover of the instruction manual, wherein the opened edge of the paper portion of the paper slip is bound with the back cover so that a document storage portion is formed between an inner side of the back cover and the paper portion, with a document insertion slot formed on the back cover.

According to the arrangement of the second aspect, documents such as the guarantee certificate attached to the electronic device can be inserted through the document insertion slots of the instruction manual and stored in the document storage portion so that they can be stored without being lost, and the documents can be stored easily through the document insertion slots into the document storage portion without having to open the instruction manual, since the document insertion slots are formed on the outer side of the back cover of the instruction manual.

A third aspect of the present invention provides the instruction manual of an electronic device according to aspect 1 or aspect 2, wherein the document insertion slot includes a first document insertion slot formed linearly in the horizontal direction of the instruction manual, and a second document insertion slot formed linearly and slanted with respect to the first document insertion slot, wherein names of documents to be inserted respectively through the first and second document insertion slots to the document storage portion are printed on the back cover.

According to the arrangement of the third aspect, since the names of documents to be inserted through each of the first and second document insertion openings are printed to show what type of document is to be inserted through the first document insertion slot and what type of document is to be inserted through the second document insertion slot, and since the second document insertion slot is slanted with respect to the first document insertion slot, it becomes easier for the user to distinguish the first document insertion slot from the second document insertion slot compared to the case where the two document insertion slots are formed in parallel without an angle.

A fourth aspect of the present invention provides the instruction manual of an electronic device according to the third aspect of the invention, wherein the document inserted through one of the first and second document insertion slots is a guarantee certificate for guaranteeing the electronic device.

According to the arrangement of the fourth aspect, the guarantee certificate that comes with the electronic device and that may easily be lost can be stored in the document storage portion by inserting through the first document insertion slot or the second document insertion slot, so that the possibility of losing the guarantee certificate is reduced significantly.

### BRIEF DESCRIPTION OF THE DRAWINGS

FIG. 1 is a perspective view showing the state in which an instruction manual that comes with an electronic device according to embodiment 1 is viewed from a front side;

FIG. 2 is a perspective view showing the state in which the same instruction manual is viewed from the rear side;

FIG. 3 is an explanatory view showing the state in which a guarantee certificate and a notification paper are stored in the instruction certificate; and

FIGS. 4A, B, C, and D are an explanatory view showing the binding process of the instruction manual according to embodiment 2.

### DETAILED DESCRIPTION OF THE PREFERRED EMBODIMENTS

Now, the preferred embodiments for carrying out the present invention will be described. Of course, the present invention is applicable to cases other than those described in the preferred embodiments within the scope of the present invention.

### Embodiment 1

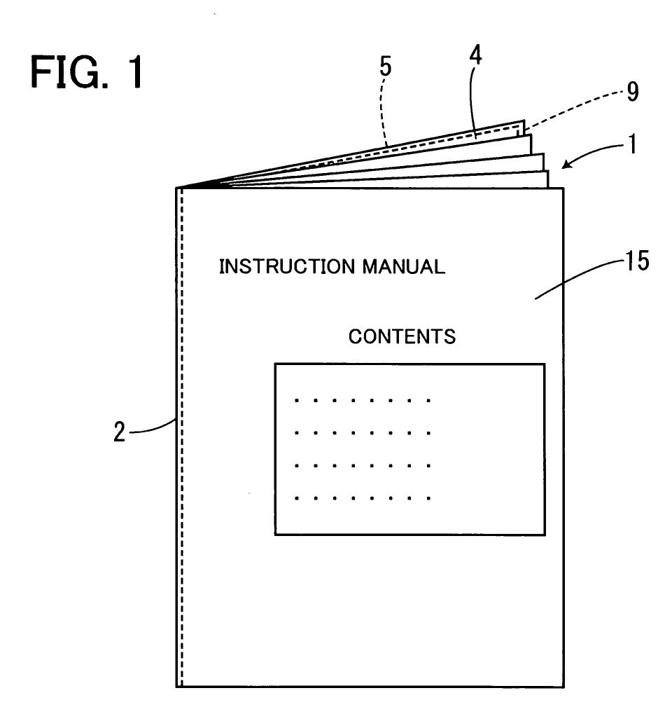

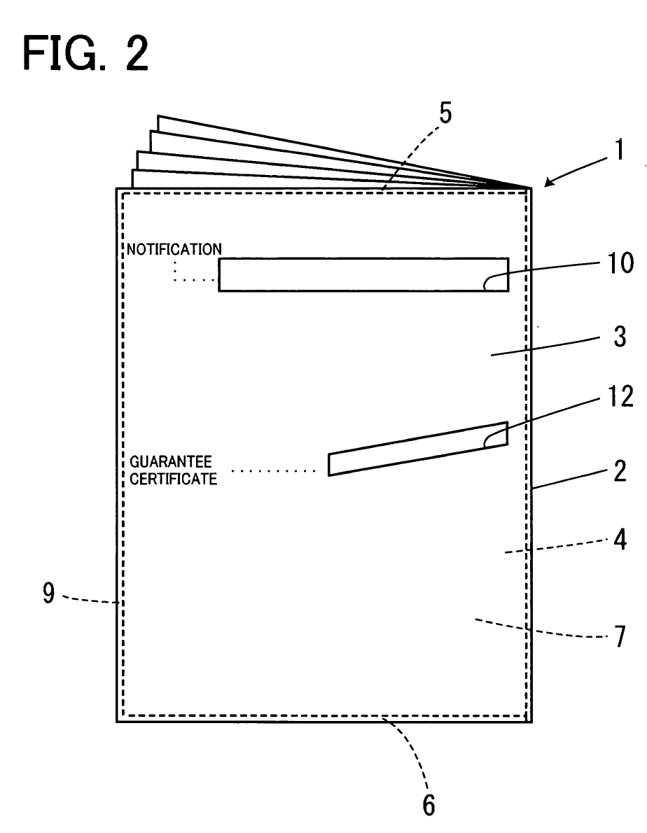

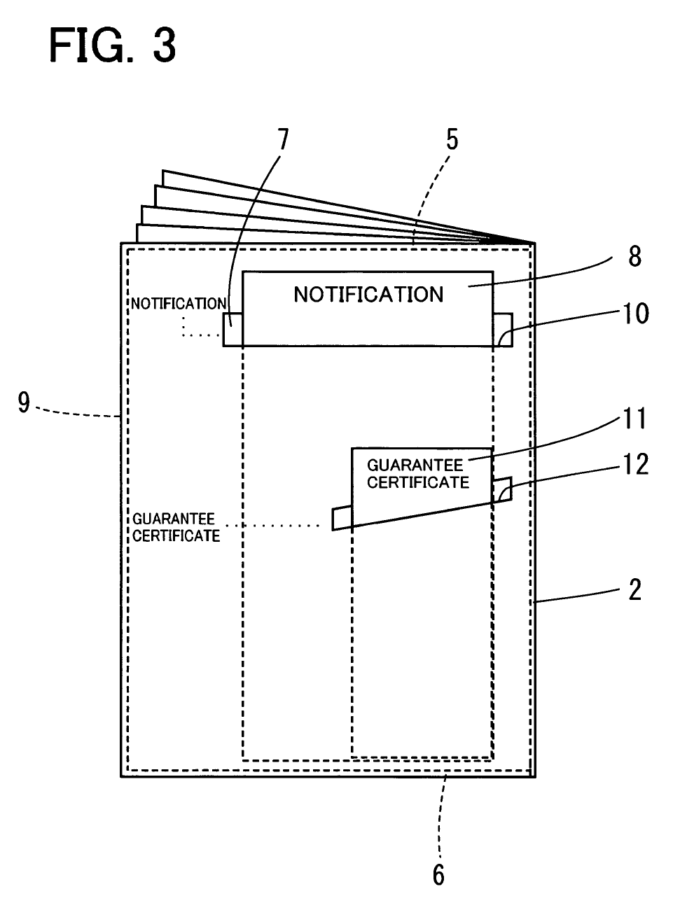

FIG. 1 is a perspective view showing the state in which an instruction manual that comes with an electronic device according to embodiment 1 is viewed from a front side, FIG. 2 is a perspective view showing the state in which the instruction manual is viewed from a rear side, and FIG. 3 is an explanatory view showing the state in which a guarantee certificate and a notification paper are stored in the instruction manual. The instruction manual 1 is attached to a product such as an electronic device, wherein multiple papers of the same size to which are printed instructions and the like are piled up and the rear portion 2 thereof is bound so that the instruction manual can be spread in the left and right directions.

A back cover 3 and a paper portion 4 overlapped with the back cover 3 of the instruction manual 1 have their upper edges 5, lower edges 6 and side edges 9 bound via gluing and the like, thereby forming a document storage portion 7 having its peripheral edges sealed in the shape of a pocket between the inner side of the back cover 3 and the paper portion 4 overlapped with the back cover 3, which can store documents such as guarantee certificate and the like mentioned in detailed later so as to prevent the documents from getting lost.

The back cover 3 has a first document insertion slot 10 which is shaped linearly and horizontally with respect to the instruction manual 1 for inserting a notification paper having printed thereto information such as a “notice” to be notified to the user, and a second document insertion slot 12 which is shaped linearly and slanted instead of being parallel with respect to the first document insertion slot 10 for inserting the guarantee certificate 11 of the electronic device. Documents are stored in the document storage portion 7 through the first and second document insertion slots 10 and 12. Moreover, since the first and second document insertion slots 10 and 12 are formed on the outer side of the back cover 3 instead of on the inner side of the instruction manual 1, the documents can be stored in the document storage portion 7 through first and second document insertion slots 10 and 12 without opening the instruction manual 1, unlike the prior art in which the document insertion slots such as pockets for storing documents are disposed on the inner side of the notebook or booklet.

Moreover, the characters “NOTIFICATION” corresponding to the notification paper 8 are printed near the first document insertion slot 10, that is, at a distance of 10 mm from the first document insertion slot 10, indicating the type of document to be inserted through the first document insertion slot 10. Further, the characters “GUARANTEE CERTIFICATE” denoting the second document insertion slot 12 via dotted lines are printed on the back cover 3, indicating the type of document to be inserted through the second document insertion slot 12. As described, characters, dotted lines and possibly symbols are printed on the back cover 3 so as to help recognize the type of document to be inserted through the first document insertion slot 10 and the second document insertion slot 12, respectively.

As described, according to the instruction manual 1 which is the booklet according to the present embodiment, by binding the upper edges 5, the lower edges 6 and the side edges 9 positioned opposite to the back portion 2 of the back cover 3 of the instruction manual 1 and the paper overlapped with the back cover 3, a document storage portion 7 shaped like a pocket is formed between the inner side of the back cover 3 and the paper portion 4. Further, since first and second document insertion slots 10 and 12 are formed on the back cover 3, a guarantee certificate 11 or a notification paper 11 that comes with the electronic device can be inserted through the first and second document insertion slots 10 and 12 into the document storage portion 7, so as to prevent the documents from getting lost. Even further, since the first and second document insertion slots 10 and 12 are formed on the back cover of the instruction manual, that is, on the outer side of the instruction manual 1, the notification paper 8 and the guarantee certificate 11 can be stored easily into the document storage portion 7 through the first and second document insertion slots 10 and 12 without having to open the instruction manual 1. Therefore, the documents such as the guarantee certificate 11 and the notification paper 8 that come with the electronic device can be stored in the instruction manual 1 by which the documents are prevented from being lost, and there is no need to store the guarantee certificate and other various documents attached to the electronic device for example in a separate pouch, so there is no need to prepare a pouch for storage and the related costs can be cut down. Furthermore, since the guarantee certificate and the notification paper 8 are stored in the instruction manual 1, it becomes easy for both the workers at the manufacture site of the electronic devices and the purchaser to confirm the documents attached to the electronic device.

Furthermore, by printing the characters “GUARANTEE CERTIFICATE” and “NOTIFICATION PAPER” indicating the names of documents to be inserted through the first and second document insertion slots 10 and 12, respectively, into the document storage portion 7, making it easier for the user to recognize the types of documents that are to be inserted through the first document insertion slot 10 and the second document insertion slot 12, the user can insert the notification paper 8 into the first document insertion slot 10 and the guarantee certificate 11 into the second document insertion slot 12 easily without error.

In addition, the document inserted through one of the document insertion slots, which according to the present embodiment is the second document insertion slot, is the guarantee certificate 11 guaranteeing charge-free or fare-paying repair services of the electronic device at least for a predetermined period of time, so by storing the guarantee certificate 11 and other important documents such as the notification paper 8 that come with the electronic device that may easily be lost can be stored together with the instruction manual 1, the possibility of losing documents such as the guarantee certificate 11 and the notification paper 8 is reduced.

In addition, the shapes of the first and second document insertion slots 10 and 12 are not restricted to those illustrated in FIG. 2 and the like, and the slots can be formed as slit-shaped cuts formed on the back cover 3. Furthermore, the first and second document insertion slots 10 and 12 are formed on the back cover of the instruction manual 1 but not restricted thereto, and they can be formed on other areas if necessary, such as on the front cover 15 of the instruction manual 1 which is on the opposite side from the back cover 3. Moreover, arrows or other symbols can be used to show the second document insertion slot 12 instead of the dotted line. In addition, a guarantee certificate 11 is presented as an example of the document for guaranteeing charge-free or fare-paying repair service of the electronic device at least for a predetermined period of time according to the present embodiment, but the guarantee certificate 11 of the present embodiment is not restricted to the meaning of the term “guarantee certificate”, and other similar types of documents can be handled equivalently as the guarantee certificate 11 of the present embodiment.

### Embodiment 2

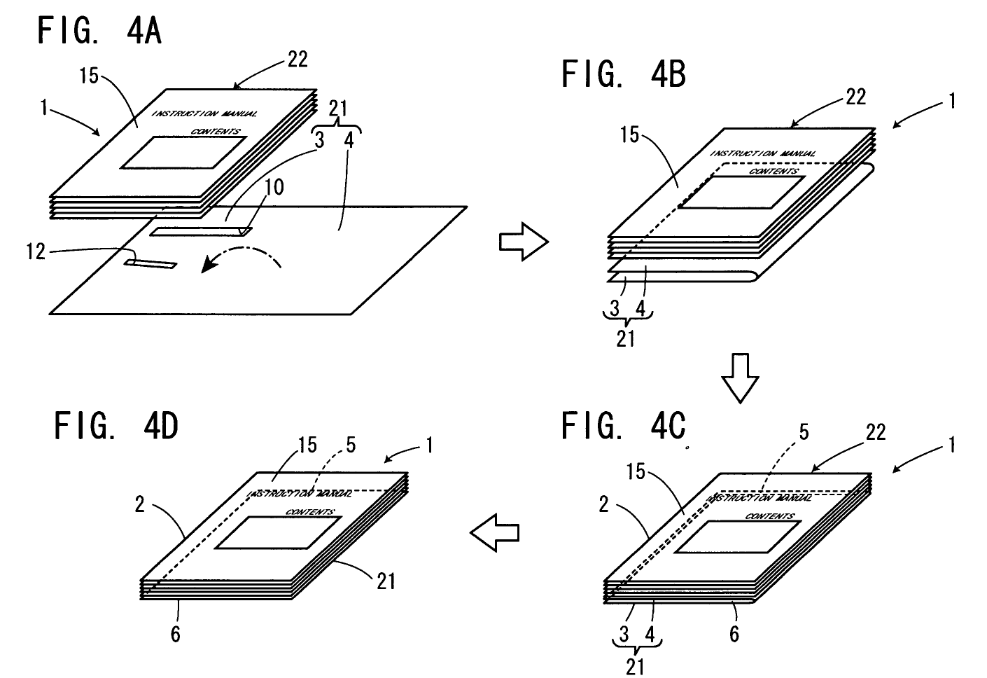

FIG. 4 is an explanatory view showing the binding process of the instruction manual according to embodiment 2, wherein the equivalent portions as embodiment 1 are denoted with the same reference numbers, and the detailed descriptions thereof are omitted. The instruction manual 1 according to embodiment 2 comprises a paper slip 21 having integrated the back cover 3 and the paper portion 4 of embodiment 1, and when binding the bundle of paper 22 including a number of papers and the front cover 15 with the paper slip 21 folded in half and having formed thereto the first and second insertion slots 10 and 12, at first, the paper slip 21 not folded in half as shown in FIG. 4A is folded as shown in FIG. 4B. Next, as shown in FIG. 4C, the folded paper slip 21 is overlapped with the bundle of paper 22 so that the side of the paper slip 21 opposite from the side being folded in is positioned on the rear side, and the paper slip 21 is bound with the bundle of paper 22 to form a rear portion 2. Thereafter, as shown in FIG. 4D, the upper edge 5 and the lower edge 6 which are the opened edges of the paper slip 21 are bound to form a document storage unit 7 having the outer edges closed. Thereby, according to embodiment 2, the operation according to embodiment 1 for closing the side edges 9 by bonding and the like to form the document storage portion 7 between the back cover 3 and the paper 4 overlapped with the back cover 3 is no longer necessary, and the binding process of the instruction manual 1 is simplified, so that the manufacture costs can be suppressed low.

The effects of the present invention are as follows.

According to a first aspect of the present invention providing an instruction manual of an electronic device having a rear portion bound so that the instruction manual can be spread in the horizontal direction, wherein upper edges, lower edges and side edges opposite from said rear portion of a back cover of the instruction manual and a paper portion overlapped with the back cover are bound together to form a document storage portion between the inner side of the back cover and the paper portion, having a document insertion slot formed on the back cover; documents such as the guarantee certificate that come with the electronic device can be stored in the instruction manual itself, and there is no need to store the guarantee certificate or other various documents that come with the electronic device in a separate pouch or the like, so the costs related thereto can be suppressed since there is no need to prepare pouches. Moreover, since documents such as the guarantee certificate and the notification paper can be stored in the instruction manual, the workers at the manufacture site and the purchaser can easily confirm whether there is a document missing or not to be attached to the electronic device.

According to a second aspect of the present invention providing an instruction manual of an electronic device having a rear portion bound so that the instruction manual can be spread in the horizontal direction, comprising a paper slip folded in half so that a paper portion thereof overlaps with a back cover of the instruction manual, wherein the opened edge of the paper portion of the paper slip is bound with the back cover so that a document storage portion is formed between an inner side of the back cover and the paper portion, having a document insertion slot formed on the back cover; documents such as the guarantee certificate that come with the electronic device can be stored in the instruction manual itself, and there is no need to store the guarantee certificate or other various documents attached to the electronic device in a separate pouch or the like, so the costs can be suppressed since there is no need to prepare pouches. Moreover, since documents such as the guarantee certificate and the notification paper can be stored in the instruction manual, the workers at the manufacture site and the purchaser can easily confirm whether there is a document missing or not to be attached to the electronic device.

According to a third aspect of the present invention providing an instruction manual of an electronic device according to aspects 1 or 2, wherein the document insertion slot includes a first document insertion slot formed linearly in the horizontal direction of the instruction manual, and a second document insertion slot formed linearly and slanted with respect to the first document insertion slot, wherein names of documents to be inserted respectively through the first and second document insertion slots to the document storage portion are printed on the back cover; the documents to be inserted through the first document insertion slot and the second document insertion slot can be recognized easily, and the distinction between the first document insertion slot and the second document insertion slot is facilitated since the second document insertion slot is formed at an angle with respect to the first document insertion slot.

According to a fourth aspect of the present invention providing an instruction manual of an electronic device according to aspect 3, wherein the document inserted through one of the first and second document insertion slots is a guarantee certificate for guaranteeing the electronic device; the guarantee certificate which can be lost easily can be kept without being lost by storing the same in the instruction manual.

What is claimed is:

1. An instruction manual of an electronic device having a rear portion bound so that the instruction manual can be spread in the horizontal direction;
wherein upper edges, lower edges and side edges opposite from said rear portion of a back cover of the instruction manual and a paper portion overlapped with the back cover are bound together to form a document storage portion between the inner side of the back cover and the paper portion, having a document insertion slot formed on the back cover.

2. An instruction manual of an electronic device having a rear portion bound so that the instruction manual can be spread in the horizontal direction;
comprising a paper slip folded in half so that a paper portion thereof overlaps with a back cover of the instruction manual, wherein the opened edge of the paper portion of the paper slip is bound with the back cover so that a document storage portion is formed between an inner side of the back cover and the paper portion, having a document insertion slot formed on the back cover.

3. The instruction manual of an electronic device according to claim 1, wherein the document insertion slot includes a first document insertion slot formed linearly in the horizontal direction of the instruction manual, and a second document insertion slot formed linearly and slanted with respect to the first document insertion slot, wherein names of documents to be inserted respectively through the first and second document insertion slots to the document storage portion are printed on the back cover.

4. The instruction manual of an electronic device according to claim 2, wherein the document insertion slot includes a first document insertion slot formed linearly in the horizontal direction of the instruction manual, and a second document insertion slot formed linearly and slanted with respect to the first document insertion slot, wherein names of documents to be inserted respectively through the first and second document insertion slots to the document storage portion are printed on the back cover.

5. The instruction manual of an electronic device according to claim 3, wherein the document inserted through one of the first and second document insertion slots is a guarantee certificate for guaranteeing the electronic device.

6. The instruction manual of an electronic device according to claim 4, wherein the document inserted through one of the first and second document insertion slots is a guarantee certificate for guaranteeing the electronic device.
